(19) United States
(12) Patent Application Publication
(10) Pub. No.: US 2005/0001702 A1
(43) Pub. Date: Jan. 6, 2005

(54) Electromechanical valve actuator

(76) Inventors: John D. Norton, Ann Arbor, MI (US); Mark L. Hopper, Ypsilanti, MI (US); Stephen J. Newton, Ann Arbor, MI (US); Greg J. Smith, Canton, MI (US); Shawn H. Swales, Canton, MI (US)

Correspondence Address: DICKINSON WRIGHT PLLC, 1901 L. STREET NW, SUITE 800, WASHINGTON, DC, 20036, US

(21) Appl. No.: 10/866,967

(22) Filed: Jun. 14, 2004

Related U.S. Application Data
(60) Provisional application No. 60/479,169, filed on Jun. 17, 2003.

(51) Int. Cl. H01F 7/08

(52) U.S. Cl. 335/220

(57) ABSTRACT

An electromechanical valve actuator for use with an internal combustion engine. The electromechanical valve is formed by molding electromagnets in electromagnet receivers for easy formation and assembly of the electromechanical valve actuator. The molding material may include lubrication passages and cooling passages to improve the durability of the electromechanical valve actuator. A connector may also be integrally molded out of the molding material.

### CROSS-REFERENCE TO RELATED APPLICATION

This application claims the benefit of U.S. Provisional Application No. 60/479,169, filed Jun. 17, 2003, the entire disclosure of this application being considered part of the disclosure of this application and hereby incorporated by reference.

### BACKGROUND OF THE INVENTION

The present invention relates to electromechanical valve actuators and a method of assembling electromechanical valve actuators.

As engine technology advances and manufacturers strive to increase engine power, improve fuel economy, decrease emissions, and provide more control over engines, manufacturers are developing electromechanical valve actuators to replace cam shafts for opening and closing engine valves. Electromechanical valve actuators allow selective opening and closing of the valves in response to various engine conditions.

Electromechanical valve actuators generally include two electromagnets formed from a lamination stack and an embedded power coil. A spring loaded armature located between the electromagnets is movable between the electromagnets as the power coils are selectively energized to create a magnetic force to attract the armature. The surface of the electromagnets to which the armature is attracted when the power coil of an electromagnet is energized is generally referred to as a pole face. The armature abuts to the valve so that as the armature moves between pole faces in pole-face-to-pole-face operation, the valve is opened and closed.

In operation, as an electromagnet is energized, the armature is drawn to the pole face of that electromagnet. As the armature plate approaches the pole face, the gap between the pole face and armature plate, generally referred to as the air gap, decreases. As the air gap decreases, the magnetic force acting on the armature exponentially increases, causing the armature to increase in velocity as it approaches the pole face of the energized electromagnet. The increase in velocity increases the force of the impact of the armature against the electromagnet, causing noise vibration and harshness concerns. Due to the impact of the armature plate on a pole face, quiet operation of electromechanical valve actuators may be challenging to achieve.

To reduce noise, vibration, and harshness issues and obtain quiet operation, many manufacturers have attempted to dampen movement of the armature through active energy absorption systems. Most of these energy absorption systems use fluid dampers, such as a piston or shock, supplied with fluid to dampen the impact force of the armature. Under normal engine operating conditions, the armature cycles between electromagnetic pole faces about 700 to 5000 times per minute. These fluid energy absorption systems need to be configured to allow quick resetting of the energy absorption system to absorb the next impact. One problem with fluid energy absorption systems is that it is difficult to provide fluid to the dampers without decreasing the efficiency of the electromagnets. For example, additional holes drilled into the lamination stack of the electromagnets decreases their efficiency, and such a decrease in efficiency requires additional power to be supplied to the electromagnet to properly and consistently attract the armature plate to the pole face. A decrease in efficiency also requires additional power to hold the armature plate to the pole face so that the valve remains open or closed for a desired time period. Any requirement of additional power puts increased demand on today's already overloaded vehicle electrical systems.

Electromechanical valve actuators also operate in high temperatures with very short cycle times. It is difficult to provide lubrication to armature stems without decreasing the magnetic efficiency of the electromagnets. Lubrication is generally required between the armature stem and lining. Separate oil lines may be added to the top and bottom of the electromechanical valve actuators to provide lubrication to each electromagnet lamination stack, but these oil lines add additional manufacturing costs and assembly time, and increase the package size of the electromechanical valve actuator.

Electromechanical valve actuators are traditionally formed by creating a lamination stack from individual laminated plates, machining an armature hole and, if the electromechanical valve includes an energy absorption system, machining damper holes. For proper operation, the armature holes are machined perpendicular to the armature plate and therefore in a linear electromechanical valve actuator, typically perpendicular to the pole face. With the lamination stack assembled and machined, a power coil may be inserted within a coil cavity on the lamination stack. The power coil is held in place by filling voids in the cavity with epoxy. The assembled electromagnets are then secured within c-channels with fasteners. For example, the electromagnet may be bolted to the c-channel, or a bolt may pass through a passage on each side of the electromagnet and couple the electromagnet to each side of the c-channel. Properly positioning the electromagnets within the c-channels during assembly is difficult due to various tolerance stack ups. Properly assembling the c-channels into a complete electromechanical valve actuator with the armature plate between the electromagnets so that the pole faces of linear electromagnets are parallel with the armature plate and so that the stem passages in the armature electromagnet and valve electromagnet are aligned is difficult and time consuming. Any misalignment of the armature stem passage creates excessive wear and friction caused heat.

### SUMMARY OF THE INVENTION

An electromechanical valve actuator for use with an internal combustion engine. The electromechanical valve is formed by molding electromagnets in electromagnet receivers for easy formation and assembly of the electromechanical valve actuator. The molding material may include lubrication passages and cooling passages to improve the durability of the electromechanical valve actuator. A connector may also be integrally molded out of the molding material.

The electromechanical valve actuator generally comprises an electromagnet receiver, an electromagnet and a molding material coupling the electromagnet to the electromagnet receiver. The electromechanical valve actuator is assembled by placing the electromagnet within the electromagnet receiver and placing the electromagnet receiver with the inserted electromagnet into a die. When inserted into the die, the electromagnet and the electromagnet receiver are substantially separated to define a void therebetween. The die is then closed and the void is filled with a molding material to structurally secure the electromagnet to the electromagnet receiver.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a perspective of an electromechanical valve actuator;

FIG. 2 is a sectional view of the electromechanical valve actuator;

FIG. 3 is a perspective view of the valve electromagnet secured within the valve c-channel with the molding material partially removed to show internal components;

FIG. 4 is a perspective view of the valve electromagnet secured within the valve c-channel and including an energy absorption system, with the molding material partially removed to show internal components;

FIG. 5 is a partial sectional of the EMVA showing fluid channels formed within the molding compound for lubricating the armature passages;

FIG. 6 is a partial sectional of the EMVA showing fluid channels formed within the molding compound to provide fluid to an energy absorption system;

FIG. 7 is an exploded perspective view showing the c-channel, molding pins and molding tubes;

FIG. 8 is a perspective view showing the molding pins disposed within the c-channel and ready to receive an electromagnet;

FIG. 9 is an exploded perspective view showing the c-channel, molding pins and molding tubes for an EMVA having an energy absorption system;

FIG. 10 is a perspective view showing the molding pins disposed within the c-channel and ready to receive an EMVA having an energy absorption system;

FIG. 11 is a perspective view of an electromagnet, including energy absorption system, disposed within the c-channel and located on a molding die base plate;

FIG. 12 is a perspective view of an electromagnet within a c-channel and disposed within a die, ready to receive molding material;

FIG. 13 is a perspective view of the electromagnet and c-channel disposed within the die and receiving molding material;

FIG. 14 is a sectional view of a lever electromechanical valve actuator; and

FIG. 15 is a perspective view of the lever electromechanical valve actuator secured in a die ready to receive molding material.

### DETAILED DESCRIPTION OF THE PREFERRED EMBODIMENT

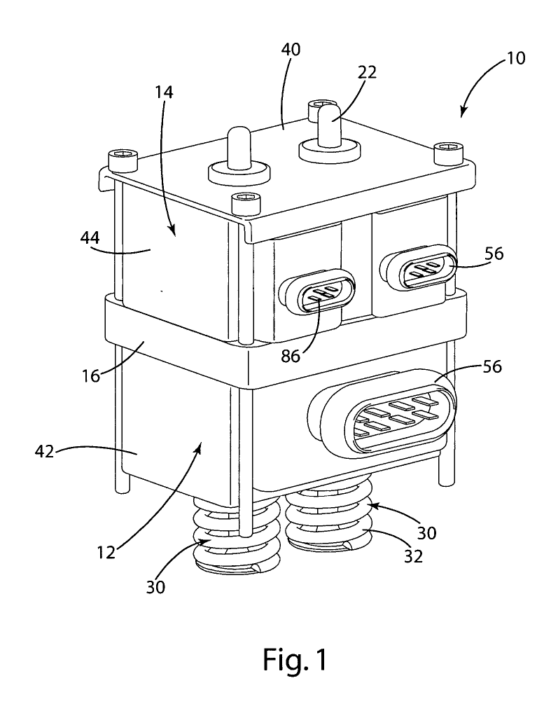

A linear electromechanical valve actuator 10, typically mounted on an internal combustion engine (not shown) to open and close the valves (e.g. the intake or exhaust valves), is illustrated in FIG. 1. The electromechanical valve actuator 10 generally includes a valve portion 12 separated from an armature portion 14 by a spacer 16. The electromechanical valve actuator 10 further includes an electromagnet assembly 60 having a valve electromagnet 72 and an armature electromagnet 74. The valve portion 12 includes a valve c-channel 42 and the valve electromagnet 74. The armature portion 14 includes an armature c-channel 44 and the armature electromagnet 74. The valve electromagnet 72 and the armature electromagnet 74 are secured within the respective valve channel 42 and armature c-channel 44 with a molding material 50. The molding material 50 allows assembly of the electromechanical valve precisely and efficiently and allows easy changes to the shape and configuration of the electromechanical valve actuator. An armature assembly 20 is situated between the electromagnets 72, 74 in a gap 18 defined by the spacer 16, valve portion 12, and armature portion 14.

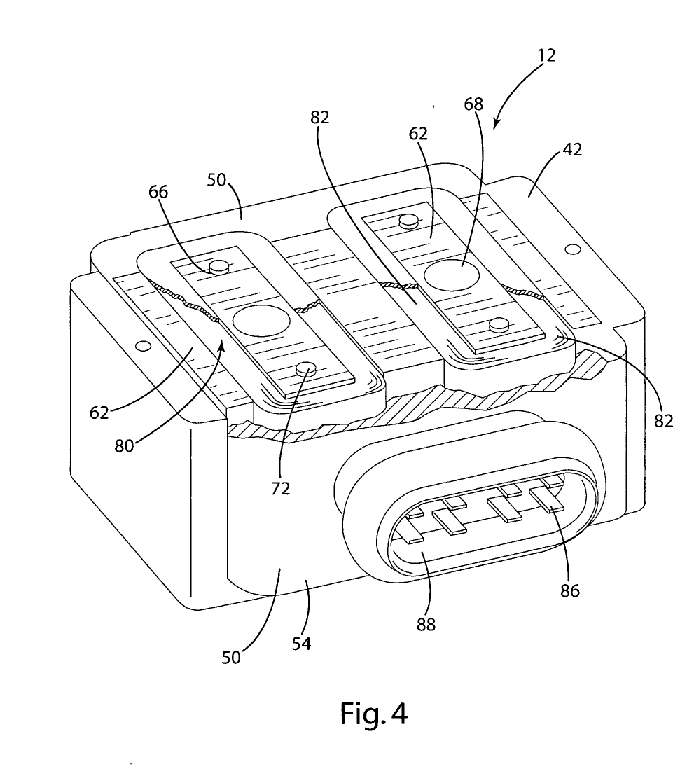

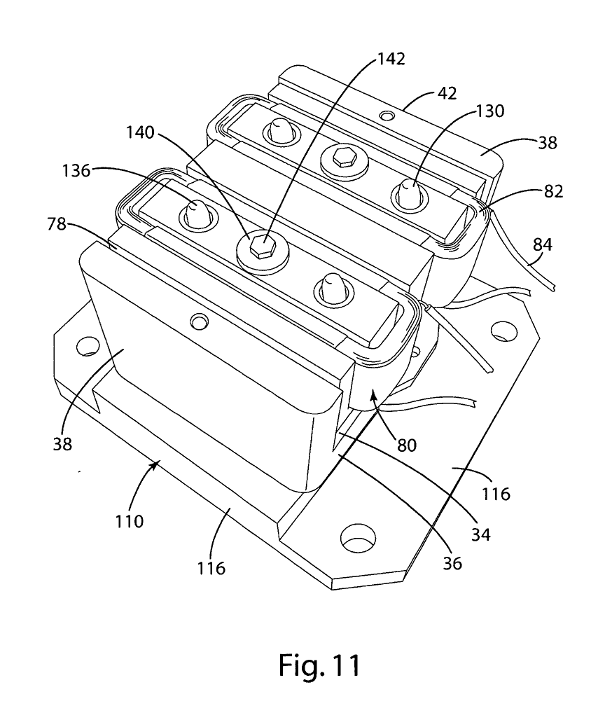

The electromechanical valve actuator 10 drives an engine valve (not shown) to open or close a valve port on the engine to selectively allow the flow of gases in and out of a cylinder. The electromechanical valve actuator 10 may include an optional energy absorption system 90 to reduce noise, vibration, and harshness issues by reducing or eliminating the force of impact of the armature assembly 20 against the electromagnets 72, 74 during operation. More specifically, the energy absorption system 90 extracts kinetic energy from the armature assembly 20, thereby slowing the armature assembly 20 as it approaches the pole face 70 of the electromagnets 72, 74. The electromechanical valve actuator 10 may further include an energy absorption system 90 as illustrated in FIGS. 4, 6, and 11-13 to reduce noise, vibration, and harshness concerns associated with typical electromechanical valve actuators when the armature plate 24 impacts the pole face 70 of the electromagnets 74, 76 during operation. The present invention allows easy formation and assembly of an electromechanical valve actuator whether or not an energy absorption system 90 is included. Although the energy absorption system 90 is generally illustrated as being located on the sides of the armature stem 22, the energy absorption system may easily be located around the armature stem 22. The energy absorption system 90 may be formed from an elastic or compressible material, or a metallic material such as steel, and may further include a hydraulic dampening mechanism to reduce or eliminate the force with which the armature plate 24 impacts the pole face 70.

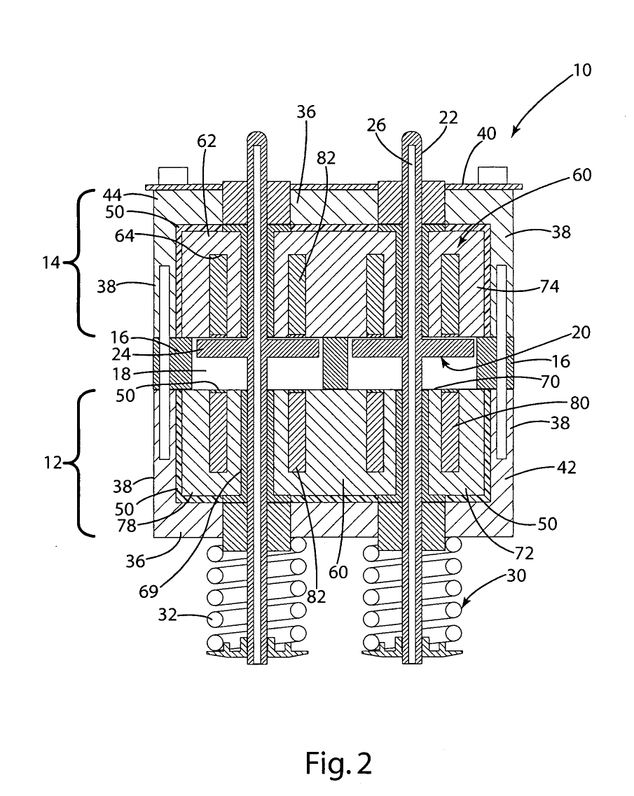

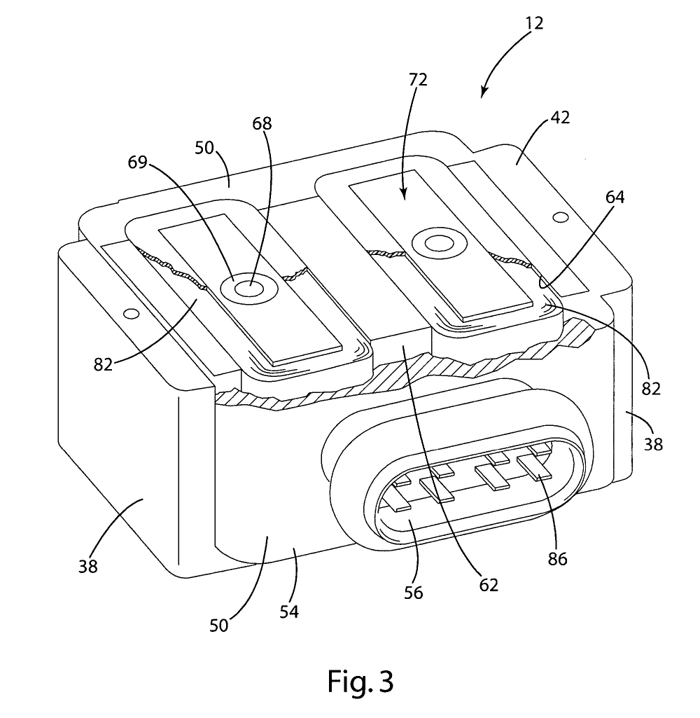

The armature assembly 20 includes an armature plate 24 and an armature stem 22 as illustrated in FIG. 2. A linear electromechanical valve actuator 10 is illustrated in FIGS. 1-13, where the armature stem 22 passes through the armature electromagnet 74 and valve electromagnet 72. The armature stem 22 may include a hollow passage 26 to allow passage of fluid such as oil from one side 12, 14 of the electromechanical valve actuator 10 to the other side 12, 14. The armature plate 24 is generally formed from laminated plates (not shown) to improve the magnetic efficiency of the electromechanical valve actuator 10, reduce the flex of the armature plate 24 during operation, and improve the durability of the electromechanical valve actuator 10.

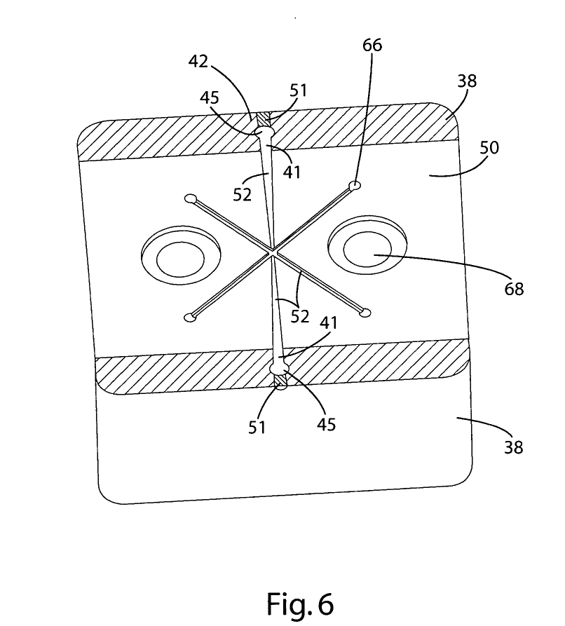

The electromagnet assembly 60 includes the valve electromagnet 72 and the armature electromagnet 74, each having a pole face 70. When assembled, the pole faces 70 of the valve and armature electromagnets 72, 74 oppose each other with the armature plate 24 disposed in the gap 18 therebetween. Each of the electromagnets 72, 74 includes a lamination stack 62 and a power coil 82. The lamination stack 62 is generally formed from laminated sheets (not shown) and defines a coil cavity 64 and an armature stem passage 68. The stem passage 68 may be lined with an armature liner 69. The lamination stack 62 may also define optional bumper passages 66 (FIG. 6) if the electromechanical valve actuator 10 includes an energy absorption system 90. The power coil 82 is partially disposed within the coil cavity 64 as illustrated in FIG. 4.

The power coils 82 are generally formed as is well known in the art and are connected to a source of electric current (not shown) through the lead wires 84. The lead wires may terminate in end connectors 86 to allow easy assembly and integration of the electromechanical valve actuator 10 to the engine. The electromagnets 72, 74 are selectively energized by a controller (not shown) such as an engine management system. As the power coils 82 are selectively energized, a magnetic field is created in and around the electromagnets 72, 74 to attract the armature plate 24 to the energized electromagnet 72, 74. The shape of the power coils and the lamination stack 62 may be tailored to adjust the size, shape, and configuration of the magnetic field to attract the armature plate 24 with maximum efficiency to the pole face 70 of an energized electromagnet 72, 74. As the controller selectively energizes alternating electromagnets 72, 74, the armature plate 24 cycles between pole faces 70 of the electromagnets 72, 74 to drive the engine valve between open and closed positions. Once in motion, a spring assembly 30, such as the illustrated armature spring (not shown) and valve spring 32, provides the force to move the armature assembly 20, specifically the armature plate 24, from pole-face-to-pole-face with the electromagnets 72, 74 controlling the movement of the armature plate 24. The electromagnets 72, 74 also may secure the armature plate 24 to one of the pole faces 70 temporarily to hold the valve in an open or closed position for a desired length of time.

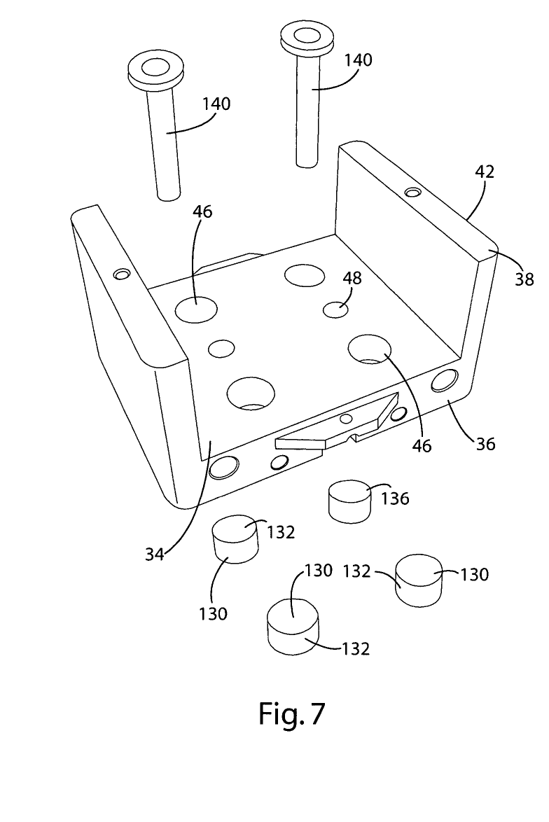

The valve c-channels 42 and the armature c-channels 44 act as electromagnet receivers and are generally formed as is well known in the art, but include openings to allow die members, such as the illustrated molding pins 130, to locate the electromagnets during the molding process. The c-channels 42, 44 include a base 36 and sides 38. The base 36 generally includes the openings, such as the illustrated pin openings 46 and armature hole 44. The pin openings 46 allow die pins, such as the molding pins 130, illustrated in FIGS. 7-10, to pass through the base 36 of the c-channels 42, 44 to raise the electromagnet 72, 74 from the top surface 34 of the base 36. The pin openings 46 and the armature hole 44 may be configured in a variety of sizes and shapes and may be located on the base 36 wherever desired. The c-channels 42, 44 are typically formed from aluminum by an extrusion process. Although not illustrated, the pin openings 46 may be threaded to receive a threaded molding pin 130. The threads may be configured to stop the molding pin when the top surface 136 of the molding locator 134 is a set distance above the top surface 34 of the c-channel base 36.

The molding material 50 is generally any material that is: capable of securing the electromagnets 72, 74 to the c-channels 42, 44 over the life of the electromechanical valve actuator 10; resistive to oil swelling; non-electrically conductive; thermally conductive; and durable against wear from heat and friction. Low shrinkage of the molding material 50 while curing is also desirable to keep the electromagnets 72, 74 aligned during the curing process. Many two part epoxies formed from a resin and a hardener fit these characteristics. As illustrated in FIG. 2, the electromagnets 74, 76 are secured within the c-channels 42, 44 with a molding compound 50, such as the epoxy traditionally used to secure the power coil 82 within the coil channel 64. Epoxies that work well for the present invention are generally two part epoxies, including a resin and a hardener. It has been found that a resin containing aluminum oxide provides the benefits listed above. One epoxy that is particularly suited well includes Huntsman Araldite™ CW5960 resin with Huntsman Aradur™ HY5960 hardner. By molding the electromagnets 72, 74 to the c-channel 42, 44 in a die 110, the assembly process is simplified, shortened, and consistently provides the correct alignment of the electromagnets 72, 74.

The molding material 50 may also form end faces 54 of the valve portion 12 and armature portion, as well as part of the pole faces 70 of the electromagnets 72, 74. The end faces 54 may further include an integrally formed connector 56 also formed from the molding material 50. The end faces 54 may be formed in any size, shape or configuration to improve packaging, allow easy transitions between different vehicles and engines, and allow routing of lubrication passages. In the illustrated embodiment, the molding material 50 encapsulates the electromagnets 72, 74. The lead wires 84 are also encapsulated in the molding material 50 for protection. As illustrated in FIG. 1, on the armature portion 14, the end faces 54 may be formed with contours that match the individual electromagnets 72, 74 or as illustrated on the valve portion 12 of the electromechanical valve actuator 10 with a single end face for a pair of electromagnets arranged over a cylinder. The connectors 56 may provide the connection for a single set of electromagnets 72, 74, as illustrated on the valve side 12 of the electromechanical valve actuator 10, or two sets of electromagnets 72, 74, as illustrated on the armature side 14 of the electromechanical valve actuator 10.

The electromechanical valve actuator 10 is generally formed by molding the electromagnets 72, 74 within their respective c-blocks 42, 44 to individually form the valve side 12 and armature side 14 and then assembling the sides 12, 14 with the spacer 16 therebetween. More specifically, the valve c-block 42 and armature c-block 44 are formed to fit within mold cavities and receive the electromagnets so that a molding gap 78 is defined between the electromagnets 72, 74 and the c-blocks 42, 44. The molding material 50 is then received in the gap 78 to secure and locate the electromagnets 72, 74 relative to the c-channels 42, 44 and electrically isolate the electromagnets from the c-channels 42, 44 and rest of the electromechanical valve actuator 10.

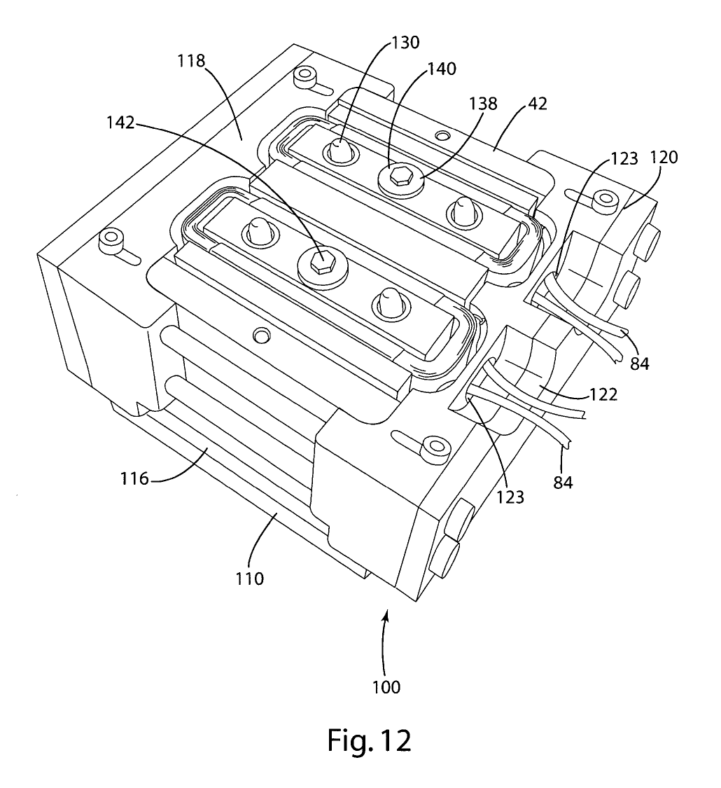

The die 110 may be formed in a variety of configurations and shapes depending on the ultimate configuration or shape of the electromechanical valve actuator 10, specifically the armature and valve sides 12, 14. As illustrated in FIG. 12, the die includes a die base 116 and die side walls 114. The die base 116 is configured to support the c-channels 42, 44 and allow the molding pins 130 to be inserted into the c-channel 42, 44. While the molding pins 130 are illustrated as being separate in FIGS. 7-10, the molding pins 130 may be made integral with the die base 116. Integral molding pins 130 allow for easier and quicker assembly times with less set up time required. The die side walls 114 are generally configured to have a shape and configuration that is a mirror image of the desired end faces 54. One of the die side walls 114 is configured to receive the lead wires 84 and form the molded connector 56, illustrated as the connector side wall 120 in FIG. 12, while the other is illustrated as a regular side wall 118. The connector side wall 120 may have a variety of configurations depending on the shape of the desired connectors, and may even include another member (not shown) which holds the end connectors 86 in place during the molding process for easy creation of the desired connector 56.

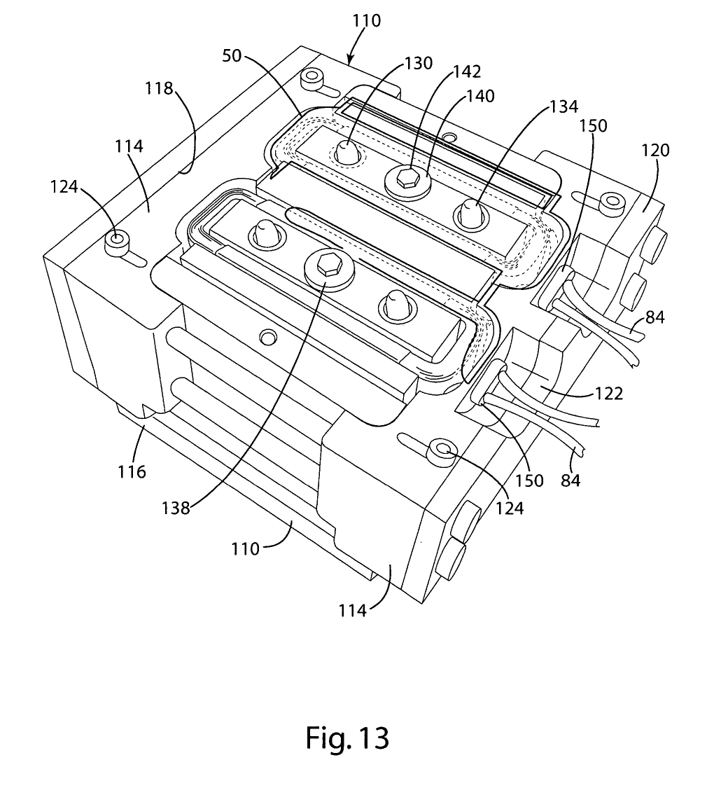

While the die 110 is illustrated in FIG. 13 as being arranged so the pole face is upright, it is anticipated for production, the die 110 will be flipped with the pole face 70 on the bottom during the molding process to allow easy formation of the molding material as part of the pole face in a substantially planar relationship with the portion of the lamination stack that forms the remaining parts of the pole face. The die sides 114 and die base 116 are only illustrative, and the die 110 could be formed as one integral piece with the c-channel and electromagnet being inserted into the defined cavity.

The method of formation of the valve side 12 or armature side 14 generally includes the steps of forming an electromagnet 72, 74 and c-channel 42, 44, inserting the electromagnet 72, 74 into the c-channel 42, 44 and inserting the combination into a die 110 with molding pins 130 spacing the electromagnet 72, 74 from the c-channel 42, 44 to create a molding gap 78. The die 110 is then closed and a molding material 50 is inserted to fill the voids by any molding process known in the art. When the molding material 50 is cured, die is removed from the molded side 12, 14. The sides 12, 14 are then assembled together with a spacer 16 and armature assembly 20 therebetweeen. The spring assembly 30 is added and the electromechanical valve actuator 10 is assembled to the engine. The method of formation and assembly of the electromechanical valve actuator will now be described in greater detail below.

The components of the electromechanical valve actuator 10, including the lamination stack 62 and power coil 82, are generally formed as is well known in the art and assembled to form an electromagnet 72, 74, before the epoxy is added to secure the power coil 82 within the coil cavity 64 on the lamination stack 62. The c-channels 42, 44 are also formed as is well known in the art, but include the illustrated pin openings 46.

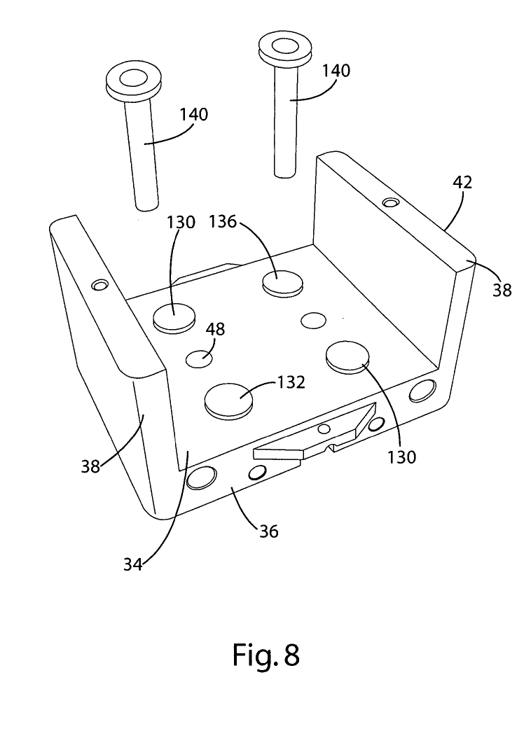

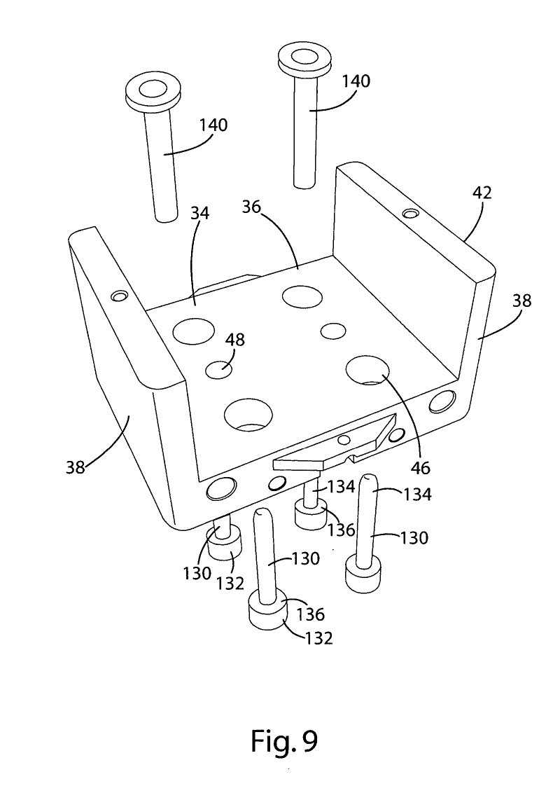

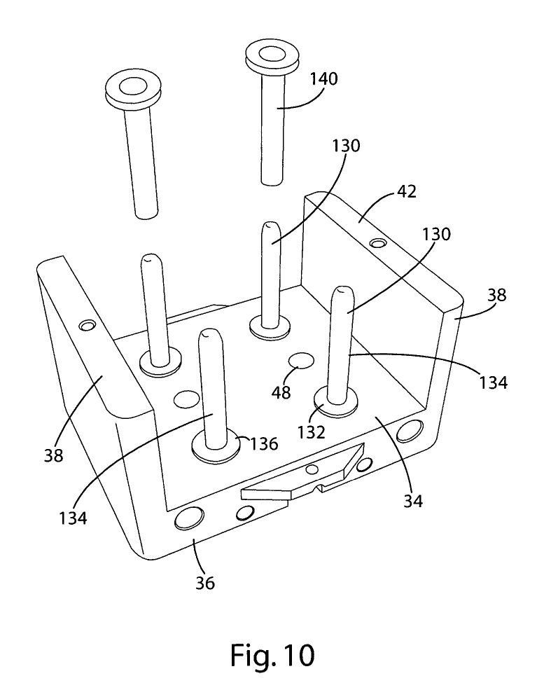

In the illustrated embodiment, the molding pins 130 are placed into the pin openings 46 on the c-channels 42, 44, and the electromagnets 72, 74 are assembled into the respective c-channels 42, 44. The assembled c-channels 42, 44 and electromagnets 72, 74 are placed on the die base 116. If no energy absorption system 90 is desired, the molding pins 130 may be formed as illustrated in FIGS. 7 and 8 where there is only a molding locator 134 and no sleeve 136. If an energy absorption system 90 is desired, the molding pins 130 may be formed as illustrated in FIGS. 9 and 10 with a sleeve 136 extending from the molding locator 134. Of course the sleeve 136, as well as the molding locator 134, may have a variety of sizes, shapes and configurations to match the size, shape and configuration of the energy absorption system 90. Further, in some instances, such as where the energy absorption system 90 is secured around the armature stem 22, the molding pins 130 may be formed as shown in FIGS. 7 and 8. To further ease the assembly process, the lamination stack 62 may also be formed with standard bumper passages 66 for use in electromechanical valve actuators 10 that do not include energy absorption systems 90. More specifically, use of the molding pins 130 without the sleeve 136, as illustrated in FIGS. 7 and 8, allow the bumper passages 66 to be filled with molding material 50 during the molding process and thereby form a planar pole face.

The die base 116 may include interlocking features (not shown) that interlock with the c-channel 42, 44 to properly align the c-channel 42, 44 within the die 110, or that interlock with the molding pins 130, which then locate the c-channel 42, 44 on the die base 116 through the pin openings 46. The electromagnets 72, 74 are then secured to the die base with the molding tube 140 and a molding fastener 142. The molding tube 140 may be formed to the size of the armature passage 68, or sized to the diameter of the opening remaining after a liner 69, illustrated in FIG. 2, has been installed. If desired, the molding tube 140 may have a diameter less than the armature stem passage 68 in the lamination stack. Therefore, when the molding material 50 is inserted into the die 110 to mold the electromagnets 72, 74 in place, the stem liner 69 is also integrally molded.

With the c-channels 42, 44 and electromagnets 72, 74 secured to the die base and aligned for molding, the die side walls 114 are installed. Although not order specific, the regular die side wall 118 may be arranged first and secured to the die base 116 with the die fasteners 124. The regular die side wall 118 is arranged a distance away from the electromagnets 72, 74, so that the end faces 54 receive the desired thickness of molding material 50 during the molding process. Next the connector side wall 120 is assembled onto the die base 116. The connector side wall 120 generally includes a connector gap 122 and a wire opening 123 as illustrated in FIG. 12. The wire opening 123 allows the lead wires 84 to extend from the power coil 82 to a controller. A wire dam 150 may be inserted as illustrated in FIG. 13 to prevent the molding material 50 from extending into the connector gap 122 through the wire opening 123. The lead wires 84 are generally coated with a silicon or any other suitable material to protect them during the molding process. If desired, the lead wires 84 may include the illustrated end connectors 86, which are then held in place by a holder (not illustrated) when the connector 56 is formed and molded within the connector gap 122. Although not all die members are illustrated for molding the connector 56, the molding process is generally well known in the art. The valve and armature sides 12, 14 may also be formed without forming the integral connector, and the lead wires 84 may extend to a remote connector (not shown).

With the die 110 being assembled around the c-blocks 42, 44 and the electromagnets 72, 74, the die 110 is then closed and the molding material 50 is inserted to form the valve side 12 and armature side 14. The molding material 50 generally flows through the die 110 to form the end faces 52, the pole face 70 above the power coils 82, between the lamination stack, and to secure the electromagnet 72, 74 within the c-channel 42, 44 without the use of fasteners.

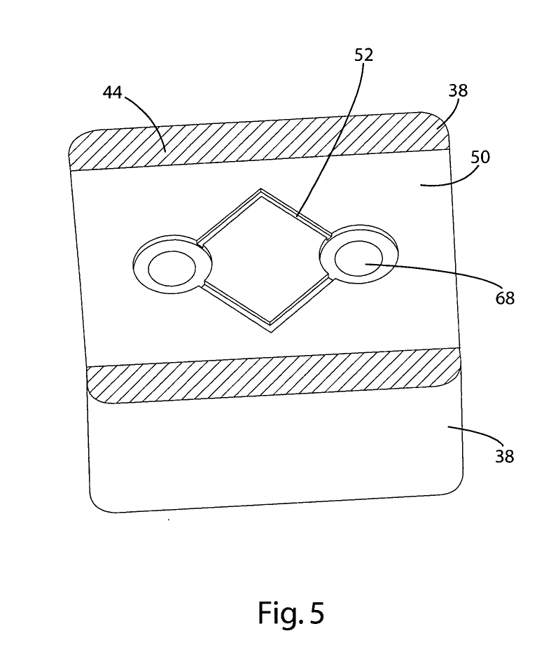

Lubrication passages 52 may be formed within the molding material 50 during the molding process to allow transfer of lubrication fluid to the armature stem 22, as shown FIG. 5 or dampening fluid as shown in FIG. 6 to reset the bumpers (not shown) of the energy absorption system 90. An exemplary method of forming the lubrication passages 52 includes adding thermoplastic tubes (not shown) that stay in the molding material 50 when the molding material 50 hardens. Another method of forming the lubrication passages 52, includes the use of tapered pins (not shown) that extend through the c-channel 42, 44 into the gap 78. The holes 41 left in the c-channel may be sealed with a plug 51, as shown in FIG. 6. In the illustrated embodiment, the plug 51 does not interfere with the c-channel passage 45 that may pass through the one c-channel 42, 44 of one side 12, 14, through the spacer 16 and to the other c-channel 42, 44 where it may be in fluid communication with lubrication passages 52 on the opposing side 12, 14.

After the molding material 50 cures, the die 110 is removed from the valve side 12 and armature side 14. The electromechanical valve actuator 10 is then assembled as is well known in the art with the spacer 16 and armature assembly 20 between the sides 12, 14 and attached to the engine.

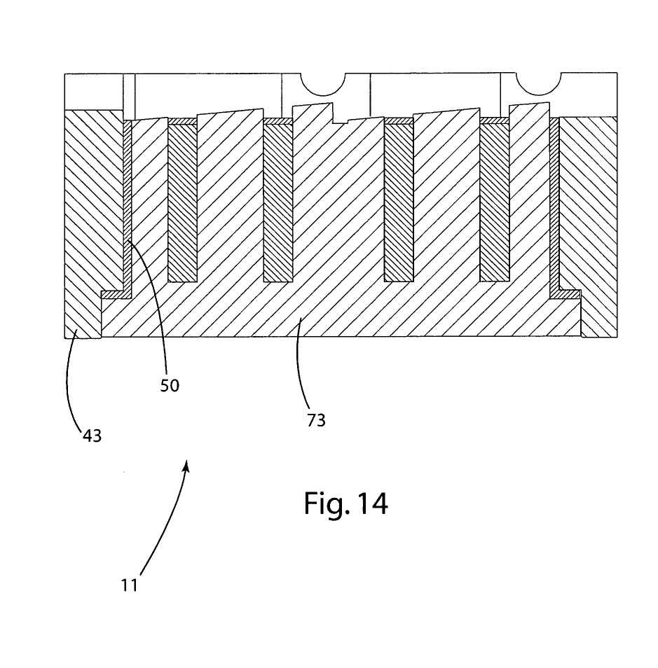

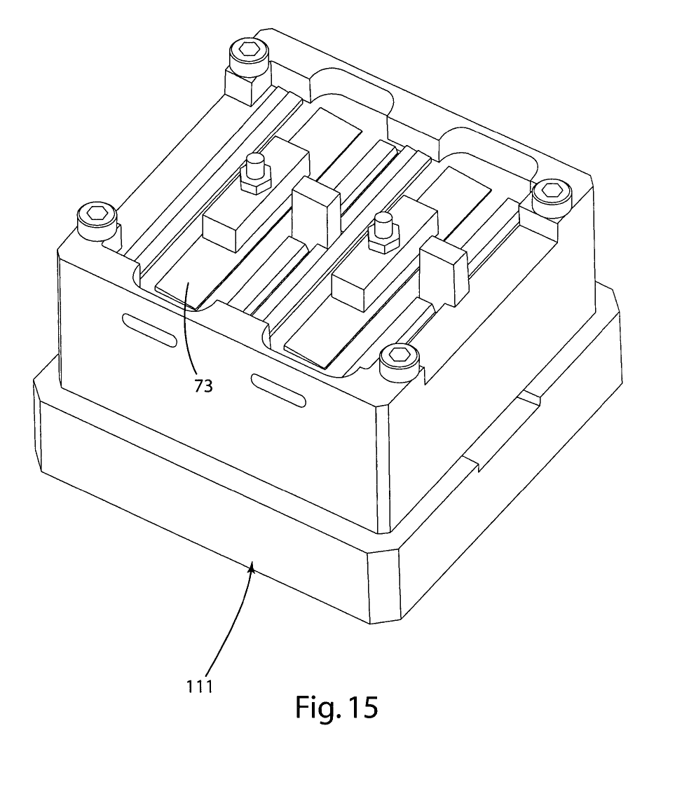

As shown in FIGS. 14 and 15, the method present invention may also be used to form lever based electromechanical valve actuators 11, in addition to the linear electromechanical valve actuator illustrated in FIGS. 1-13. The method and components are substantially the same, except that the armature hole 48 is not needed in the c-channels 42, 44 for lever electromechanical valve actuators. More specifically, as illustrated in FIG. 14, the lever c-channel 43 may be formed without a base. An illustrative die 111 is shown in FIG. 15 for molding a lever electromechanical valve actuator. Because no molding pins 130 are needed to position the lever electromagnets 73 relative to the lever c-channel 43, the molding process may be further simplified. The remaining method steps and description above may easily apply to the illustrated lever electromechanical valve actuator 11.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. An electromechanical valve actuator comprising:
an electromagnet receiver;
an electromagnet; and
a molding material coupling said electromagnet to said electromagnet receiver.

2. The electromechanical valve actuator of claim 1 wherein said electromagnet receiver is a c-block.

3. The electromechanical valve actuator of claim 3 wherein said c-block further defines pin openings.

4. The electromechanical valve actuator of claim 1 wherein said molding material is disposed between said electromagnetic receiver and said electromagnet.

5. The electromechanical valve actuator of claim 4 wherein said electromagnet includes a lamination stack having coil channels and a power coil disposed in said coil channels, said molding material retaining said power coil within said coil channels.

6. The electromechanical valve actuator of claim 1 wherein said electromagnets include lead wires terminating into end connectors and wherein said molding material forms a molded connector with said end connectors.

7. The electromechanical valve actuator of claim 5 wherein said molding material defines lubrication passages.

8. The electromechanical valve actuator of claim 7 wherein said lubrication passages extend to the provide fluid to an energy absorption system.

9. The electromechanical valve actuator of claim 1 wherein said molding material is an epoxy having a resin and a hardner.

10. The electromechanical valve actuator of claim 4 wherein said resin includes aluminum oxide.

11. The electromechanical valve actuator of claim 1 wherein said molding material is electrically insulating.

12. The electromechanical valve actuator of claim 11 wherein said molding material is capable of efficiently transferring heat.

13. The electromechanical valve actuator of claim 12 wherein said molding material is resistant to oil swelling.

14. A molding apparatus for electromechanical valve actuators comprising:
a die having a cavity for receiving an electromagnet assembly within an electromagnet receiver; and
at least one molding locator for creating a molding gap between said electromagnet receiver and said electromagnet.

15. The molding apparatus of claim 14 wherein said molding locator includes a molding sleeve extending from said molding locator to define passages for receiving an energy absorption system within said electromagnet.

16. A method of assembling an electromechanical valve actuator comprising:
placing an electromagnet within an electromagnet receiver and placing said electromagnet receiver with said electromagnet in a die, said electromagnet and said electromagnet receiver being substantially separated to define a void therebetween; and
filling said void with a molding material to structurally secure said electromagnet to said electromagnet receiver.

17. The method of claim 16 wherein said step of filling the void further includes the step of forming a molded connector.

18. The method of claim 16 further including the steps of:
assembling molding locators into said electromagnet receiver; and
placing said electromagnet receiver within said die before placing said electromagnet within said electromagnet receiver.

19. The method of claim 16 wherein said step of filling the void further includes the step of forming fluid passages in the molding material.

20. The method of claim 16 wherein said step of filling the void further includes the step of forming end faces.
